(19) United States
(12) Patent Application Publication
(10) Pub. No.: US 2022/0027848 A1
(43) Pub. Date: Jan. 27, 2022

(54) UNIVERSAL PLATFORM FOR GENERATING EXCHANGE LOCATION NETWORKS

(71) Applicant: Smiota Inc., Fremont, CA (US)

(72) Inventors: MANJUNATHA KASHI, MILPITAS, CA (US); KAILASNATH DORNADULA, FREMONT, CA (US); JYOTHI KASHI, MILPITAS, CA (US); WAHEED RASHEED, FREMONT, CA (US); RAJESH CHAGANTI, SARATOGA, CA (US)

(21) Appl. No.: 17/497,650

(22) Filed: Oct. 8, 2021

Related U.S. Application Data
(63) Continuation-in-part of application No. 16/209,191, filed on Dec. 4, 2018, now Pat. No. 11,170,339.
Application No. 16/209,191 is a continuation-in-part of application No. 17/086,391, filed on Oct. 31, 2020.

(51) Int. Cl. G06Q 10/08; G07C 9/00

(52) U.S. Cl. CPC G06Q 10/0836; G07C 9/00896

(57) ABSTRACT

The subject disclosure relates to generating a network of smart lockers and provisioning an identity of the smart lockers to requestors seeking access to smart lockers. The requestors can identify the location of candidate smart lockers based on target smart locker criteria.

### CROSS-REFERENCE TO RELATED APPLICATIONS

This application claims priority to U.S. patent application Ser. No. 16/209,191 titled “Generating Exchange Locations” filed on Dec. 4, 2018, which claims priority to U.S. Patent Application No. 62/594,168, filed on Dec. 4, 2017 and titled, “Generating Exchange Locations”. This application also claims priority to U.S. patent application Ser. No. 17/086,391 titled “Smart Locker Agnostic Operating Platform” filed on Oct. 31, 2020.

The entirety of the disclosure of the aforementioned applications are considered part of, and are incorporated by reference in, the disclosure of this application.

### TECHNICAL FIELD

The present disclosure relates to smart locker devices and more particularly, to devices, systems, and methods for generating unified networks of otherwise distributed and stratified smart locker devices.

### BACKGROUND

Given the rise of e-commerce applications and the increased transactions of goods and services in the economy, there has been an increase in the quantity of deliveries that occur. For instance, most consumers shop online and order products for shipment directly to their homes on a frequent basis (e.g., daily, weekly, monthly, etc.). However, there are many problems with current delivery logistic mechanisms. For instance, the last mile delivery problem describes the movement of a delivery package from a transportation hub to a destination such as a residential home or business center.

Often, the last leg of the delivery route poses serious cost-effective logistical problems for couriers. For instance, in some cases, delivery of a package in the last mile to the receiver can cost 33% of the total cost comprising delivery expenses. Furthermore, other delivery problems that contribute to delivery inefficiencies include delivery re-attempts, package theft, and the choice of many individuals to stay at home to safely retrieve delivered parcels, which decreases productivity of such individuals.

Accordingly, there are several problems associated with the logistics of package delivery for couriers and consumer drop off and pick-up of packages. For instance, delivery personnel have a limited selection of drop off and pickup options that often pose inefficient route and travel concerns. Furthermore, consumers also have limited options for locations to drop off and pickup packages. Also, to the extent users utilize smart lockers as a means to conduct package pickup or drop off, such smart lockers are distributed amongst various random locations (e.g., retail stores), employ varying incompatible technologies, and operate discretely in an independent capacity. All such problems require solutions or technologies to overcome such issues.

### SUMMARY

The following presents a summary to provide a basic understanding of one or more embodiments of the invention. This summary is not intended to identify key or critical elements or delineate any scope of the particular embodiments or any scope of the claims. Its sole purpose is to present concepts in a simplified form as a prelude to the more detailed description that is presented later. In one or more embodiments described herein are systems, devices, apparatuses, computer program products and/or computer-implemented methods that employ system components to generate a unified network of smart locker devices.

One exemplary aspect, includes a system, comprising one or more processors and one or more storage devices comprising processor executable instructions that, responsive to execution by the one or more processors, cause the system to perform operations. In an embodiment, a smart locker device can execute a locker application on one or more processor of the smart locker device. The locker application employs a universal interface configured to communicatively couple with a hardware component of the smart locker device. In another aspect, one or more server device executes a server application to communicatively couple with the locker application. The smart locker device and another smart locker communicatively couple with one another via the server device to generate a smart locker exchange network.

### BRIEF DESCRIPTION OF THE DRAWINGS

FIG. 1 illustrates a non-limiting example environment that can be used to generate an exchange location network in accordance with one or more embodiments described herein.

FIG. 2 illustrates a non-limiting example of a server device in accordance with one or more embodiments described herein.

FIG. 3 illustrates a non-limiting example of a client device in accordance with one or more embodiments described herein.

FIG. 4 illustrates a non-limiting example of a locker delivery operating system in accordance with one or more implementations.

FIG. 5 illustrates an example, non-limiting system for generating a network of exchange locations for smart lockers in accordance with one or more implementations.

FIG. 6 illustrates an example, non-limiting method that can be utilized to generate a smart locker exchange location network in accordance with one or more implementations.

FIG. 7 illustrates an example, non-limiting method that can be utilized to generate a smart locker exchange location network in accordance with one or more implementations.

FIG. 8 illustrates a block diagram of an example, non-limiting operating environment in which one or more embodiments described herein can be facilitated.

FIG. 9 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section. One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

In an aspect, disclosed herein are systems and methods for generating a universal platform that allows smart locker service providers (e.g., commercial and individual owners of smart lockers) and smart locker requestors to interact within a unified network of smart lockers regardless of smart locker installation. While the smart lockers can vary by location, they can also vary by ownership, type, kind, make, model, feature-set, configuration, operability, service capabilities, and other such variations. Regardless of the smart locker variations the universal platform can interface with any smart locker variation in any location via a universal locker delivery operating system configured to communicate with the universal platform for generating exchange location locker networks. Thus, the universal platform allows for unification of otherwise distributed and stratified smart locker devices and service provisioning.

Furthermore, the universal platform can allow a wide array of audiences such as smart locker consumers, users, couriers, owners, and other stakeholders to identify each other, interact and communicate, transact with one another, and respectively operate, use, and interface with smart locker devices. As a non-limiting example, a consumer seeking to use a smart locker for picking up or dropping off a parcel may wish to use a smart locker at a particular time of day and within proximity to a target location (e.g., workplace, home, etc.). The consumer device via an executable application can communicatively couple with the universal platform (e.g., applications executing on server device(s)) and receive an array of information such as the identity of smart lockers within a target range of the workplace, attributes of various lockers (e.g., commercial locations, residential locations, smart locker configurations and available features), smart locker service offerings (e.g., refrigerated lockers, inventory storage, pick-up, drop-off, sanitization of parcels, approved route for some or all couriers, etc.), generate a route from one or more location to one or more smart locker destination (e.g., workspace to the smart locker location), generate a map, and other such features.

In another aspect, the universal platform can be utilized by courier devices. For instance, a parcel delivery and pickup service may emply an application executing on the courier device to communicatively couple with the universal platform. The courier device can execute commands and retrieve information and insights related to smart locker services. For instance, the courier device can identify smart lockers available for pickup or drop-off, identify parcels along its route for pickup or drop-off, generate a new and more efficient route to perform courier services at available smart lockers within the exchange network. Furthermore, independent third-party user devices can access the platform and register as independent couriers to perform pickup and drop-off services with respect to the smart lockers. For instance, a user device can register as a courier and offer courier services to other user devices in the network (e.g., requestors of pick-up and drop-off services, smart locker services, etc.).

In a non-limiting embodiment, platform server device(s) 102 can communicatively couple to smart lockers 108 via locker computing device(s) 106. Locker computing device(s) 106 can be a smart device such as a tablet or smartphone. Locker computing device(s) 106 can employ LDOS module 180 configured to communicatively couple (and connect via a USB connect) locker computing device(s) 106 to smart locker device(s) 108 and further communicatively couple locker computing device(s) 106 with platform server device(s) 102 via network 114. As such, platform server device(s) 102 can be configured to execute operations, provision commands, and control smart locker device(s) 108 through locker computing device(s) 106. In another aspect, LDOS module 180 can communicate with a universal interface circuit integrated within smart locker device(s) 108, such circuit configured to communicate with LDOS through a command and control protocol. In an aspect, LDOS module 180 and the universal interface circuit integrated into smart locker device(s) 108 generate a hardware abstraction structure that allows programmatic control of hardware resources in a diverse array of smart lockers (e.g., different type, kinds, manufacturers, configurations, specifications, etc.) due to universal hardware interface components (e.g., universal interface circuit) and the LDOS module 180 universal routines configured to communicate with universal interface circuit.

As a result, LDOS module 180 creates a hardware abstracted capability that enables platform server device(s) 102 to integrate with a wide array of differentiated smart locker device(s) 108 to generate a network of smart lockers of all different types, kinds, and capabilities. In one embodiment, the network of different smart lockers can be identified via each smart locker location such that smart locker services and smart locker service requests can be paired between requestor devices and service provider devices. Furthermore, platform server device(s) 102 enables all such smart locker device(s) 108 in the network to provision smart locker services at the smart locker location and engage with service requestors via the network as well as intermediary service providers (e.g., delivery personnel, couriers, etc.). The smart locker network allows smart locker service provider devices to offer associated smart locker device(s) 108 for use by a wide spectrum of user devices. Furthermore, the universal network can generate a network of otherwise stratified, distributed smart lockers into a community of connected network smart locker devices.

In another aspect, LDOS module 180 can execute by a processor of a device component (e.g., tablet computing device) of smart locker device 108. Furthermore, the abstraction capability allows for communication, control, command provisioning, instruction provisioning, data provisioning, data retrieval, instruction retrieval, and interfacing with physical hardware components of the smart locker device(s) 108. As a non-limiting example, LDOS module 180 can interface with an array of hardware components and hardware variations through command module 184 and 186. Command modules 184 and 186 are configured as LDOS universal hardware programming interfaces and each respective command module can communicate with a different smart locker effectively operably connecting the smart lockers. As such, various smart lockers configured with different manufacturing specifications (e.g., motherboards, circuit boards, relays, electronics, sensors, etc.) can be configured to communicate with LDOS universal hardware programming interfaces. Furthermore, LDOS allows the operability and control functions of the smart locker to be abstracted away from the hardware components of any smart locker. This hardware abstraction configuration allows LDOS to execute a range of operations for any smart locker and import smart locker service capabilities and functionality to such smart lockers.

Alternatively, or additionally, core application layers of locker computing device(s) 106 and application services provisioned via platform server device(s) 102 to smart locker device(s) 108 (via locker computing device(s) 106) can communicate with LDOS module 180 instead of directly communicating with individual hardware components of smart locker device(s) 108. As such, LDOS Module 180 is configured as a hardware specific operating system that unburdens any program layers (e.g., application layers, business rules layers, etc.) from having to generate hardware-dependent instructions. As such, programmatic operations can be deployed to any smart locker device(s) 108 without the need of understanding and customizing the deployment to a particular smart locker hardware. This generates efficiencies in deployment, processing, and operability in the smart locker device(s) 108.

In a non-limiting example, smart locker device(s) 108 can be configured with a device (e.g., tablet computer, smartphone, personal digital assistant, etc.) execute LDOS module 180. LDOS module 180 is configured to communicate with the universal electrical circuit configured into any variety of smart locker device(s) 108. Furthermore, LDOS module 180 can provision operable commands to smart locker device(s) 108 based on executable tasks received by platform server device(s) 102 or application device(s) 103. As such, the smart locker device(s) 108 can execute tasks, communicate, execute operations, receive commands, transmit instructions, exchange data and information with platform server device(s) 102 and hardware components of smart locker device(s) 108 simultaneously via LDOS module 180. For instance, a smart locker device 108 can execute operations (e.g., door lock, door unlock, sensor activation, proximity detection, etc.), schedule/reserve compartment availability, adjust temperature settings within storage compartments, initiate ultraviolet sanitization mechanisms, perform package label reading operations, trigger events (e.g., message notifications to/from user devices), and perform an array of functions controllable at the LDOS level and executed by the smart locker.

In another instance, the platform server device(s) 102 allows for the onboarding of smart lockers via smart locker service provider devices (e.g., client device(s) 104). For instance, a smart locker service provider device may initiate an onboarding request of a smart locker device(s) 108 into platform server device(s) 102. Accordingly, such service provider device may transmit (e.g., scan) serial number data associated with the smart locker device(s) 108 to a module executing on platform server device(s) 102. Furthermore, the serial number can be correlated (e.g., via one or more relationship model), with smart locker information within one or more database (e.g., database(s) 160) such information including locker type, kind, make, model and functionality. Furthermore, a serial number can indicate whether a smart locker is integrated with LDOS module 180 or the items required for integration.

Once a smart locker device is integrated with LDOS module 180 and universal interface circuit, the smart locker service provider device can provision the smart locker device availability for smart locker service requestors. Furthermore, the smart locker service provider can provision requirements for use of the smart locker. Once the smart locker and respective service offerings are implemented within the network, the platform server device(s) 102 (e.g., executing smart locker platform module 106) can generate maps, routes, and information related to the smart lockers for other devices to view. For instance, the platform server device(s) 102 can provision to client device(s) 104 a view of all smart locker device(s) available for respective service offerings and based on any other defined requirements.

Additional examples may be implemented with respect to the systems, methods, and processes disclosed herein. Furthermore, any of the examples described herein can provide that methods, techniques, and actions performed by a computing device are performed programmatically through use of code or computer-executable instructions, where programmatic steps may or may not be performed automatically. Any such instructions can be stored in one or more memory components of a computing device. Furthermore, any one or more example implementations within this disclosure may employ modules, engines, or components, which may communicate with one another and work inter-operatively. In some instances, a hardware component may employ a module or component independent of other modules or components. In other respects, a module, engine or component may exist independently of other modules or components. Also, any such module, engine or component may include a program, part of a program routine, sub-routine, or a software component or a hardware component capable of performing one or more tasks or functions.

In other respects, computing devices described herein can include processors, memory devices, and other such resources. In an instance, one or more processors and one or more memory resources may be implemented on servers, mobile devices, smartphones, desktop computers, cellular phones, network resources, personal digital assistants, laptop computers, tablet devices, smart locker devices, printers, digital cameras, or any other such computing devices. Furthermore, any method, device, or system implementation or example of a method, device or system may use one or more memory, processor, network resource.

In other respects, examples disclosed herein may use executable instructions by one or more processor, such instructions may or may not be executed on a computer-readable medium. In one or more examples disclosed here, a machine with processing resources and computer readable mediums on which instructions for implementing examples can be executed. Furthermore, machines disclosed in some examples may include one or more processor and/or memory configured to store data and instructions. In some instances, a computer-readable medium can represent a memory storage device, server device, hard drive, flash memory, portable storage units, CD or DVD units, personal computer, and other such memory devices. Examples of machines can include smart lockers, computers, terminals, network devices (e.g., smartphones) and other such machines that use processors, memory and instructions stored on computer readable mediums.

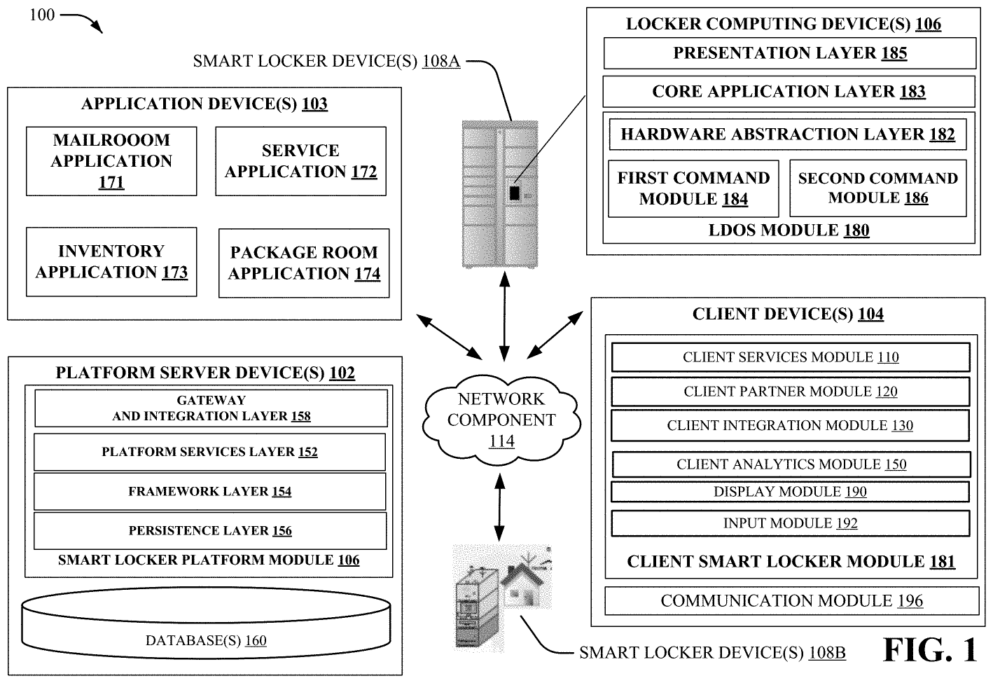

Turning now to FIG. 1, illustrated is a non-limiting example environment 100 that can be used to generate an exchange location network in accordance with one or more embodiments described herein.

In an aspect, environment 100 can include an example system used to generate an exchange location network of smart lockers in accordance with one or more implementations. Environment 100 can include platform server device(s) 102, application device(s) 103, client device(s) 104, and locker computing device(s) 106, smart lockers 108 (e.g., smart locker devices 108A and 108B), and network component 114 that, in concert, can provide a universal platform to generate a network of smart lockers identified by locations. The smart locker devices 108 can be offered for use by smart locker service provider devices and reserved for use by service requestors represented by courier device(s), consumer device(s) or other user device(s).

The device(s) disclosed herein can be a desktop computing device, a mobile phone, a tablet, a laptop, a smart watch, and any other suitable device. Furthermore, platform server device(s) 102 can be one or more server device(s) that can employ various layers such as gateway and integration layer 158, platform services layer 152, framework layer 154, and persistence layer 156. In an instance, gateway and integration layer 158 can be configured to execute a broad array of tasks such as accepting application programming interface (API) calls for the platform server device(s) 102, aggregating services required to fulfil API calls, and remitting results from associated with the calls (e.g., data).

As such, gateway and integration layer 158 can be configured as an interface to communicate data with other device interfaces (e.g., smart locker device 108A, application device(s) 103, locker computing device(s) 106, client device(s) 104). In another aspect, gateway and integration layer 158 can provide access to platform server device(s) 102 via secure access channels over network component 114. In an aspect, such secure channels can include methods such as remote procedure call (RPC) restful API's, scripting access, Simple Object Access Protocol (SOAP) and other secure methods such methods utilizing access keys to allow authorized users to access platform server device(s) 102.

In yet another aspect, gateway and integration layer 158 can enable deployment of consistent functionality from an application regardless of the access modality (e.g., user interface, mobile device, integration access, etc.). In an aspect, any of the layers within platform server device(s) 102 may be employed by a separate server device(s) in order to generate clear abstraction between layers, support scalability of the system and generate processing efficiencies to support several device interactions and requests simultaneously. In yet another aspect, gateway and integration layer 158 can be configured to communicate with external devices.

As such, layer 158 can represent any combination of hardware, software, and/or firmware configurable to facilitate the exchange of information (e.g., images such as package label images, addresses such as mailing addresses, commands such as smart locker commands, queries, instructions, audio, video, analytics information, messages, authentication results, audit trails, query results, tracking information, and other such information. In another aspect, layer 158 can employ physical communication ports, such as audio ports, display ports, serial ports, parallel ports, Universal Serial Bus (USB) ports, keyboard ports, and other such ports to connect with other devices over network component 114. In an aspect, network component 114 can be configured as a communication network that enables bi-directional links between various computing devices. As an example, network component 114 can employ multiple interconnected communication networks and interconnected elements including, but not limited to Wireless local area network (WLAN) with Ethernet access, a wireless telecommunication network interconnected with the Internet, a wireless (Wi-Fi) access point connected to the Internet, an Internet of Things (IoT) network such as a smart locker network, and so forth. In this example, network component 114 can connect application device(s) 103, platform server device(s) 102, client device(s) 104, locker computing device(s) 106, and smart locker(s) 108.

In some implementations layer 158 can include one or more protocol stacks corresponding to a network component 114, over which data is exchanged. Furthermore, the protocol and associated with firmware that employs hardware to generate signals and/or process messages used to maintain a wireless and/or wired communication session. For instance, a wireless session can be maintained between platform server device(s) 102 and smart locker 108 or client device(s) 104. In an aspect, layer 158 can include computer networking ports including, but not limited to File Transfer Protocol (FTP) port, Hypertext Transfer Protocol (HTTP), Transmission Control Protocol (TCP), User Datagram Protocol (UDP), Internet Message Access Protocol (IMAP) port, and other such ports. In some implementations, layer 158 can employ data transfer formats such as JavaScript Object Notation (JSON) to effectuate data transfers between platform server device(s) 102 and other device(s).

In another aspect, platform server device(s) 102 can employ platform services layer 152 configured to centralize access to data and functions of platform server device(s) 102 within the platform services layer 152, abstract changes to internal implementations, and allow for deployment of service versions over time without effecting other layers due to the layer abstraction. For instance, if any events are adjusted within any services provisioned by platform services layer 152, then gateway and integration layer 158 functionality continue operability and is not effected due to platform services layer 152 abstraction. In an aspect, platform services layer 152 can define a set of operations associated with a particular service and coordinate operational responses to other layers within platform server device(s) 102 and external device(s) such as application device(s) 103, locker computing device(s) 106, and client device(s) 104.

Furthermore, applications can be bounded within platform services layer 152 thus creating an abstraction of such applications from other functional layers of platform server device(s) 102. In another aspect, the applications within platform services layer 152 can be organized to share functionality, communicate with one another and contain changes (which may have an inter-application cascade effect) to any one or more applications to the platform services layer 152. As an example, services related to smart locker devices 108 may be coordinated within the platform services layer 152, and other services related to client device(s) 104 may have a different level of coordination. In case, the applications can be unified within the layer to execute tasks sometimes with repeatable target outcomes.

Platform server device(s) 102 can also employ framework layer 154 which can be configured as a set of technology components and resources to provide capabilities such as sub-service delivery capabilities. Furthermore, framework layer 154 can comprise any one or more policies, requirements, standards, principles, constraints, or sub-service capabilities contained within a framework. In an aspect, the framework layer 154 can be abstracted from the other layers and support the platform services layer 152 as well as communicate with persistence layer 156 to retrieve and restore data. Furthermore, in an aspect, framework layer 154 can execute underlying tasks or sub-service operations utilized by any one or more applications employed by platform services layer 152. In another aspect, framework layer 154 can execute object-specific tasks such as audit trails and abstract the schema associated with such objects.

In another aspect, platform server device(s) 102 can employ persistence layer 156 which can be configured to abstract data stores and provision access to data. In an aspect, the persistence layer 156 can be abstracted from data stores such that adjustments can be implemented efficiently and in isolation. For example, if a new database with different configurations and access routines is required for use with platform server device(s) 102 then the persistence layer 156 may only require an adjustment to the data access component of the layer rather than holistic changes to data storage functionality. Furthermore, given that persistence layer 156 is abstracted away from other layers, changes to data access for example won't affect business logic operations, presentation operations, service provisioning operations, and other such operations executed by the platform server device(s) 102.

In an aspect, smart locker platform module 106 can execute gateway and integration layer 158, platform services layer 152, framework layer 154, and persistence layer 156. In another aspect, platform server device(s) 102 can comprise database(s) 160. In an instance, database(s) 160 can represent any source of data and/or information. Furthermore, database(s) 160 can represent storage for data generated by platform server device(s) 102. For instance, such data can smart locker 108 locations, smart locker requirements, smart locker service offerings, user profile data, route map data, metadata, and other such information. In some implementations, information can be acquired, curated, or triggered for curation and/or acquisition based on trigger events, queries, or other such events. In an aspect, database(s) 160 can communicate with smart locker platform module 106 via persistence layer 156.

In another aspect, application device(s) 103 can represent stand-alone client applications executing on one or more server device(s) that interface with platform server device(s) 102 and smart locker platform module 106. Alternatively, or additionally, the applications can represent a browser that remotely logs onto a website hosted by a server device. Furthermore, the application can represent an application executing on a user device such as a smartphone. In an instance, application device(s) 103 can execute mailroom application 171, services application 172, inventory application 173, or package room application 174.

In another aspect, environment 100 can include smart locker device(s) 108. In an aspect, a smart locker device(s) 108 can be a locker unit comprising an array of compartments, a door to access the containment portion of the compartment, and locks to lock and unlock the door. In an aspect, platform server device(s) 102 can execute operations of the smart locker device 108. Furthermore, smart locker device(s) 108 can employ a range of functionality such as locking functionality, temperature control, refrigeration capabilities, scanner, proximity detection capabilities, elevated compartment security (e.g., controlled substance storage), compartment lighting control (e.g., LED light operability), and other such functionality. Furthermore, smart locker device 108A can represent a commercial smart locker such as one or more locker bank. Smart locker device 108B can represent a residential smart locker such as one or more locker bank for utility at a residential property (e.g., in a garage of a single-family residence).

In various instances, smart locker 108 can be configured to execute modules interconnected with a series of sensors (e.g., GPS, proximity sensor, gyrometer, NFC sensor, weight sensor, door motor control components, light sensors, temperature sensor, humidity sensor, etc.). In another aspect, smart locker 108 can execute USB, Wi-Fi, and Bluetooth modules to connect and communicate with external devices. In another aspect, smart locker 108 can employ one or more camera devices. In other aspect, smart locker 108 can employ one or more carrier board, application processor board, etc. In an aspect, the carrier board can comprise indicator lights, power inputs, battery charger, battery voltage monitor, internal power converter, Wi-Fi module (e.g., to act as a Wi-Fi access point), cellular module (e.g., firmware application to utilize cellular connectivity), communication interfaces, power controls, lock control and interface mechanisms, accelerometer, gyroscope, PIR sensor, environmental sensor (e.g., temperature, humidity, pressure and air quality data), CAN interface, Keypad, scanner interface, audio input, and/or audio output.

In another aspect, smart locker device(s) 108 can be configured with one or more processor board(s). In an aspect, a processor board can comprise an integrated wireless technology (e.g., BLE module), processor module, memory such as a flash memory (e.g., for data logging, etc.), converters, physical connections to the carrier board (e.g., via pin headers) to enable interchangeability of boards, and battery voltage monitors. In an aspect, the systems and subsystems of the processor board can be operable via firmware. In another aspect, the processor board can operate in various states to conserve processing operations and enable more functionality with the smart lockers.

Various states can include power on state, inactivated state, idle state, awake state, manual input state, emergency/notification state, and/or application interaction state. As an example, in the awake state the processor board can trigger awake via an occurrence of an application interaction, manual input interaction, notification occurrence, or other occurrence. The implementation of such states can enable low battery usage during idle times and enable energy saving capabilities of smart lockers such that the smart locker can remain operable for longer periods of time. In another aspect, the smart locker 108 processor board can transition to a low power state based on occurrence of various events such as low battery remaining, vandalism, door remaining open, high temperature, low temperature, high humidity, and/or low humidity.

In another aspect, smart locker device 108 can comprise a locker computing device 106 such as a tablet or smartphone. Furthermore, such device 106 can employ an LDOS module 180 a core application layer 183, presentation layer 185 (e.g., a user interface, for rendering at a device display, to translate tasks and results for user consumption). In an aspect, presentation layer 185 can receive input, instructions, and data and transmit such input, instructions and data to core application layer 183 or externally to smart locker platform module 106 or other external device modules. Furthermore, presentation layer 183 can use a GUI to display information related to the smart locker device and allow for operability of such smart locker device (e.g., control functions, unlock doors, access compartments, etc.). In another aspect, application layer 183 can be configured to control and execute the functionality and tasks of smart locker applications (e.g., comprising various modules). In an non-limiting embodiment, application layer 183 may be multi-tiered.

In an aspect, LDOS module 180 can employ hardware abstraction layer 182 configured to communicate with hardware components of smart locker device 108 such as motherboards, carrier boards, processor boards, sensor components and other hardware of smart locker 108. In another aspect, LDOS module 180 can employ first command module 184 and second command module 186. In an aspect, module 184 can communicate via a command-and-control protocol with a smart locker device of a first type or kind (e.g., manufactured by a first party).

In another aspect, module 186 can communicate via a command-and-control protocol with a smart locker device of a second type or kind (e.g., manufactured by a second party) where the first party and second party are different. As such, LDOS module 180 allows for the command-and-control functionality of the smart lockers to be abstracted away from the hardware of the smart locker. Furthermore, module 184 and module 186 can respectively communicatively couple with hardware of different smart lockers allowing a network of smart lockers to connect via the exchange platform. In a non-limiting embodiment, the locker computing device 106 can connect via a USB connection to a USB hub of the smart locker device 108. Furthermore, several smart lockers can daisy chain together via a USB to serial port adaptor that connects to the motherboard of a different smart locker. Several smart lockers can daisy chain connect in such a manner to form physical connections. In any event, the network exchange platform can also connect different smart lockers via network component 114 and LDOS module 180. In another aspect, locker computing device 106 can employ core application layer 183 and presentation layer 185.

In yet another aspect, environment 100 can employ client device(s) 104. A client device(s) 104 can communicate via network component 114 with platform server device(s) 102, locker computing device(s) 106 (and smart locker device(s) 108 accordingly), and application device(s) 103. A client device(s) 104 can be any device (e.g., server, smartphone, tablet, laptop, desktop computer, etc.) used to interact with the environment system component. Furthermore, client device(s) 104 can be a courier device, a locker service requestor device, a locker service provider device(s), a commercial user device(s) (e.g., smart locker owner at retail locations), a residential user device(s) (e.g., smart locker provider at a single-family home location), and other such devices which can employ client smart locker module 181.

In an aspect, client smart locker module 181 can deploy customized functionality based on the authorized role of the client device. For instance, courier devices can execute and/or initiate operations via client device(s) 104 related to package transport, pick-up and delivery, route generation, etc.). Client smart locker module 181 can employ client service module 110, client partner module 120, client analytics module 150, display module 190, and/or input module 192. Client service module 110 can be configured to access smart locker platform module 106 and/or various features provided by smart locker platform module 106 including location exchange generation capabilities and smart locker networking features. Any of the modules can indicate any combination of software, hardware, and/or firmware that can be configured to provide corresponding functionality such as functionality to generate a smart locker as part of an exchange location network.

In various implementations, client smart locker module 181 can correspond to client applications that renders a user interface on a display of client device(s) 104. Furthermore, client smart locker module 181 can communicate over network 114 to platform server device(s) 102, application device(s) 103 and locker computing device(s) 106, and smart locker device(s) 108. Furthermore, client smart locker module 181 includes the functionality of smart locker platform module 106, mailroom application 171, service application 172, inventory application 173, package room application 174 onto client device(s) 104. In an aspect, platform server device(s) 102 can represent servers that distribute aspects of smart locker platform module 106 across the multiple devices and provide cloud-based services to multiple client device(s) 104. Such use of cloud-based services allows client device(s) 104 to obtain on-demand self-service access to smart locker platform module 106, resource pooling across the cloud, rapid elasticity and adaptiveness to changing operating environments for users, services that are measurable, and access to a broad network of provider device(s) and client device(s).

In other aspects client partner module 120, includes the functionality of integrated applications (e.g., third party applications). Furthermore, client analytics module 150 can include analytics functionality of smart locker platform module 106 onto client device(s) 104 and enable further operations such as provisioning queries, retrieving analytics information, and other information. For instance, client analytics module 150 can be utilized to request analytics information about a series of smart locker devices corresponding to a client device (e.g., smart locker service provider device). Furthermore, client analytics module 150 can provision requests to acquire information about the status of a smart locker (e.g., battery life, health, power mode) or information about the smart locker use (e.g., compartments utilized, doors locked, average users per month, repeat customers, etc.).

Furthermore, client device 104 can employ display module 190 to output content for consumption by a user of client device(s) 104. In an instance, display module 190 can include capabilities to render audio, video, images, text, and other items at a user interface of client device 104. In another aspect, input module 192 can include a user interface to access features provided by smart locker platform module 106, LDOS module 180, applications of application device 103, and other applications. Furthermore, such features can include input search queries, analyzing smart locker data (e.g., scheduling, reports, dashboards, feedback, user ratings, etc.), implementing new databases for data integration. Furthermore, client device 104 can include communication module 196 configured to facilitate communications over network component 114. Communication module 196 can represent any combination of hardware, software, and/or firmware configurable to exchange or facilitate exchanges of data with other devices. In one or more non-limiting embodiments, communication module 196 can employ the same communication functions as gateway and integration layer 158 on the client device side. Client device 104 can also employ client integrations module 130.

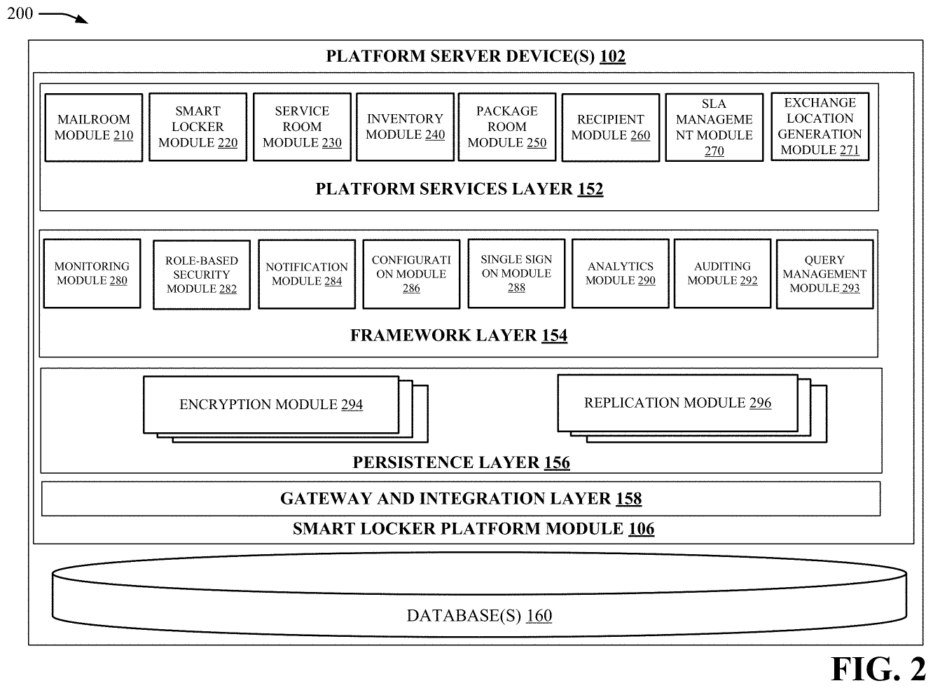

Turning now to FIG. 2, illustrated at environment 200 is a non-limiting example of a server device 102 in accordance with one or more embodiments described herein. Repetitive description of like elements employed in other embodiments described herein is omitted for sake of brevity.

In an aspect, platform server device(s) 102 can comprise hardware and software layers that include hardware and software components such as mainframes, servers, blade servers architecture servers, network components, storage devices, networks. In some embodiments, software can include components such as network application server software and database software. In an aspect, platform server device(s) 102 can be configured as an abstraction layer that can provision virtual entities such as virtual servers, virtual storage, virtual networks, virtual private networks, virtual applications, virtual clients and virtual operating systems.

Platform server device(s) 102 can also be configured as a set of functional abstraction layers provided by cloud computing environments (e.g., environment 100 in FIG. 1). As such, platform server device(s) 102 may in some embodiments comprise components, modules, layers, and deploy functions associated with those respective components, modules, layers, and functions. In some respects, platform server device(s) 102 can provision dynamic procurement of computing resources and other resources to perform tasks with a cloud computing environment, perform metering and pricing, track costs associated with resources (e.g., smart locker devices, servers, etc.), provide security (e.g., verifying identity of users), allocate cloud computing resources, ensure compliance with target service level provisioning, and other such services.

In an aspect server device(s) 102 can employ platform services layer 152 that may provide various functions associated with various applications. In an aspect, platform service layer 152 may provide workloads and functions associated with execution of mailroom module 210 (e.g., execute automated storage room tasks), smart locker module 220 (e.g., execute operations and tasks of the smart locker devices), service room module 230 (e.g., execute operations associated with managing a room such as a meeting room), inventory module 240 (e.g., execute package inventory functions such as tracking, identifying, event detecting, etc.), package room module 250 (e.g., managing automated package room facility operations), recipient module 260, SLA management module 270 (e.g., managing transactions), and exchange location generation module 271 (e.g., tasks and operations associated with generating a location exchange network). In an aspect exchange location generation module 271 can execute operational functions that generate the exchange location platform. In an aspect, module 271 can also match locker service requestor devices with locker service provider devices.

In a non-limiting embodiment, exchange location generation module 271 can execute functions such as enabling access (e.g., authentication, username, password verification, user profile generation, etc.) to exchange location functions to smart locker devices 108, client devices 104, application device(s) 103, and locker computing device(s) 106. Furthermore, exchange location generation module 271 can provision other functions such as identifying smart locker device(s) 108 for integration to the network (e.g., analyzing smart locker serial numbers, determining specifications and functionality of smart locker devices, etc.). Also, module 271 can intake requirements and restrictions associated with provisioning smart locker services (e.g., time frames for locker availability, costs of use, user access restrictions, user locker use restrictions), identify location of smart lockers, generate route maps from start points to smart locker destinations, enable matching of locker service provider devices to locker service requestor devices.

In another aspect, server device(s) 102 can employ framework layer 154 configured to execute any one or more generalized applications of bundled applications utilized by applications within platform services layer 152. Some of the applications framework layer 154 can execute include monitoring module 280 (e.g., execute smart locker device monitoring tasks), role-based security module 282 (e.g., defines roles and privileges to access smart locker platform module 106 such as courier role, service provider role, service requestor role, etc.), notification module 284 (e.g., perform notification and communication functions to external device(s) of smart locker platform module 106), configuration module 286 (e.g., functions to enable configurations of applications and capable of interfacing with an applications settings), single sign on module 288 (e.g., enables access to multiple applications via a single authenticated session), analytics module 290 (e.g., provision structure to data and data analytics processes), auditing module 292 (e.g., analysis functionality of code to determine bugs, security breaches, risks to source code, etc.), query management module 293 (e.g., enables data curation and acquisition, evaluate discrepancies in data, manage information retrieval and query analysis functions). In an aspect, query management module 293 can execute query operations and implement queries and query analytics within platform module 106.

In another embodiment, smart locker platform module 106 can execute persistence layer 156 configured to abstract the applications in framework layer 154 and platform services layer 152 from data sourcing operations. Accordingly, framework layer 154 enables smart locker platform module 106 to source data from a range of sources (e.g., database(s) 160, and external data stores), without requiring adjustments to framework layer 154 or platform services layer 152. In another aspect, smart locker platform module 106 employs gateway and integration layer 158). In another aspect persistence layer 156 employs encryption module 294 configured to encrypt data at rest. Furthermore, layer 156 employs replication module 296 configured to enhance data availability and reliability based on copying and maintaining database objects.

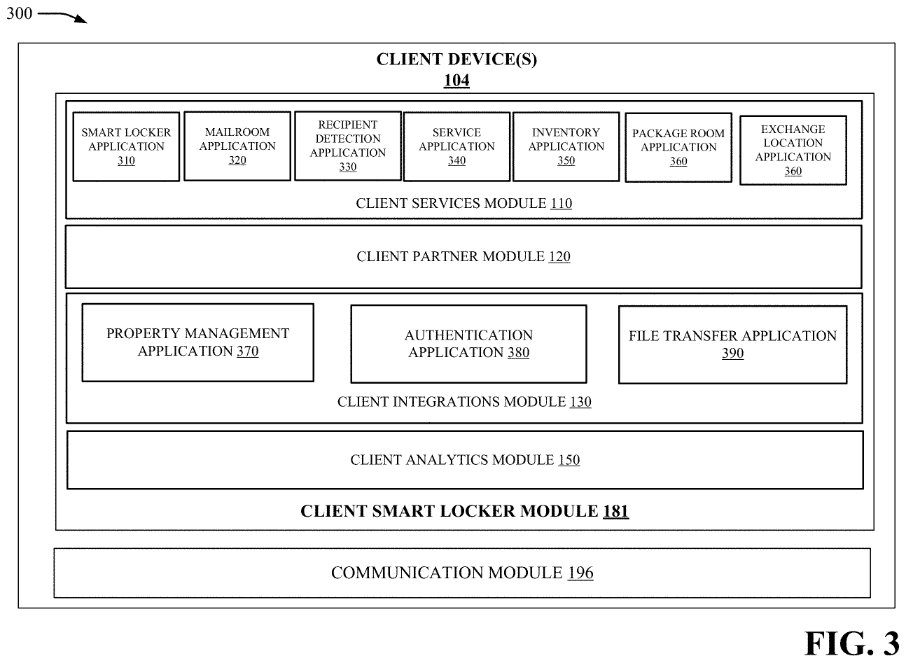

FIG. 3 illustrates a non-limiting example 300 of a client device 104 in accordance with one or more embodiments described herein. Repetitive description of like elements employed in other embodiments described herein is omitted for sake of brevity.

In an embodiment, FIG. 3 illustrates various components of an example client device 104. Client device 104 can be utilized to implement various aspects of generating exchange location networks disclosed herein. In some implementations client device 104 can include communication transceivers, that enable wired or wireless communication. Furthermore, client device 104 can execute client smart locker module 180 to employ client services module 110, client partner module 120, client integrations module 130, and client analytics module 150.

In a non-limiting embodiment, client services module 110 can execute smart locker application 310, mailroom application 320, recipient detection application 330, service application 340, inventory application 350, package room application 360, and exchange location application 360. In an aspect such applications allow for the functioning, operability and execution of tasks associated with respective applications in platform services layer 152. For example, exchange location application 360 can allow client device 104 access into features provisioned by exchange location generation module 271 such as onboarding smart lockers, identifying smart locker locations, identifying smart locker services available for courier use or consumer use, generating route maps between smart locker devices and target locations, and other such features, operations and capabilities provisioned by exchange location application 360.

In another aspect, client integrations module 130 can employ property management application 370, authentication application 380, and file transfer application 390. In an aspect, property management application 370 can provide client device 104 access into features, operations, and capabilities provisioned by mailroom application 171, service application 172, inventory application 173, and package room application 174. In yet another aspect, file transfer application 390 can provide client device 104 access into features, operations, and capabilities provisioned by framework layer 154. For instance, file transfer application 390 can retrieve or transmit SFTP files CSV files and other file types to platform services layer 152 or framework layer 154.

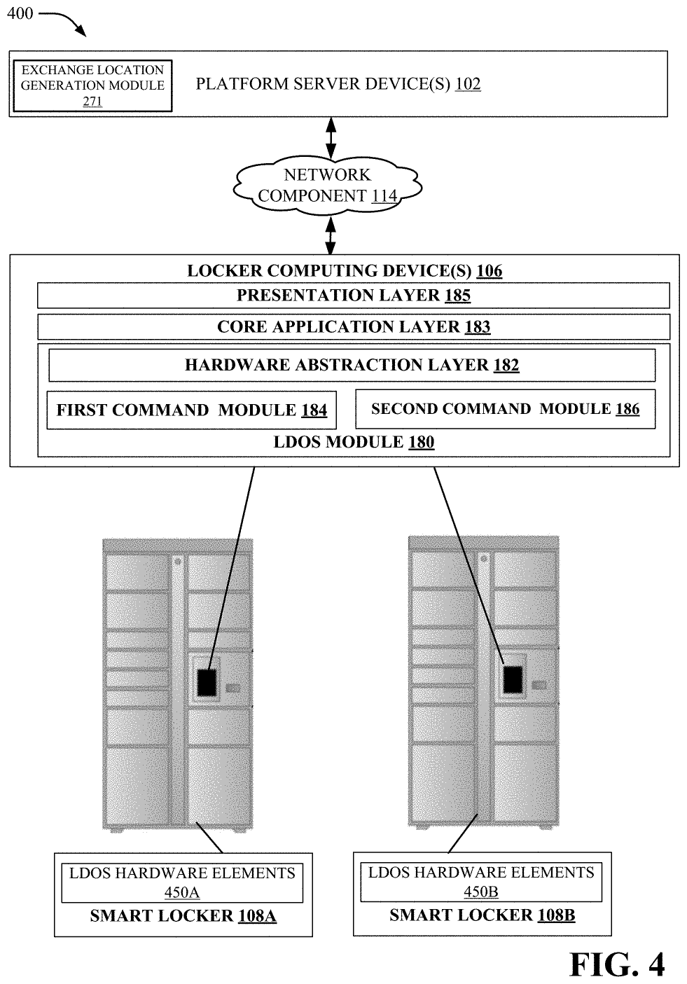

Turning now to FIG. 4, illustrates a non-limiting example 400 of a locker delivery operating system in accordance with one or more implementations. Repetitive description of like elements employed in other embodiments described herein is omitted for sake of brevity.

In an embodiment, example 400 illustrates the abstraction of smart locker hardware devices of varying smart lockers from LDOS module 180. In an aspect, smart locker 108A represents a first type of smart locker device utilizing LDOS Hardware elements 450A. In another aspect, smart locker 108B represents a second type of smart locker device utilizing LDOS Hardware elements 450B. By way of illustration, smart locker 108A can be manufactured according to different hardware specifications and components represented by hardware elements 450A. Furthermore, smart locker 108B can be manufactured according to different hardware specifications and components represented by hardware elements 450B. Regardless of their differences and general incompatibility, LDOS module 180 can communicate with both smart locker 108A and smart locker 108B in connection with universal interface circuits integrated into each smart locker 108A and 108B.

As such, LDOS Module 180 via first command module 184 and second command module 186 enables controlling the operability (hardware and software) of two very different smart locker devices 108A and 108B. Even more so LDOS Module 180 abstracts such command and control away from the physical hardware via hardware abstraction layer 182. In another aspect, the application operability between each smart locker and client device(s) or platform server device(s) 102 is also abstracting away from the smart locker device(s) via LDOS module 180. In another aspect, given the abstraction of each respective layer, platform server device(s) 102 can execute exchange location generation module 271 can provision adjustments to other layers without inefficient dependencies. In another aspect, smart locker 108A and smart locker 108B can be daisy chained to enable interoperability both via physical hardware connectivity and/or communicative coupling via LDOS module 180. Furthermore, platform server device(s) 102 can provision functionality to various different and varied connected smart lockers.

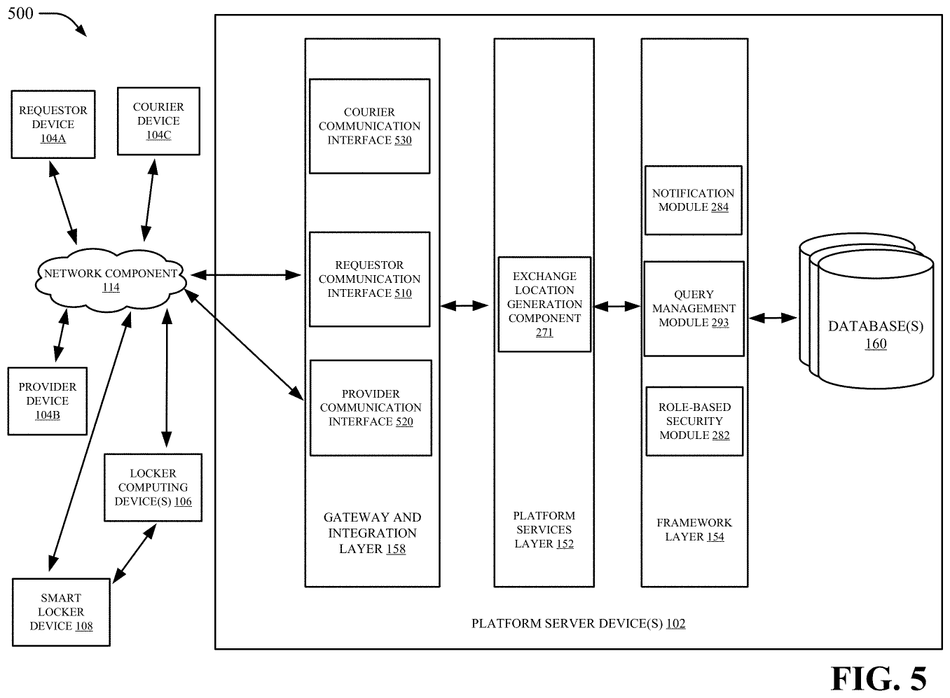

Turning now to FIG. 5, illustrated is an example system 500 for generating a network of exchange locations for smart lockers in accordance with one or more implementations. Repetitive description of like elements employed in other embodiments described herein is omitted for sake of brevity.

In an embodiment, system 500 can comprise requestor device(s) 104A, provider device(s) 104B, smart locker device(s) 108, courier device(s) 104C, locker computing device(s) 106, gateway and integration layer 158, provider communication interface 520, requestor communication interface 510, platform server device(s) 102, exchange location generation component 271, insight generation engine 540, and database(s) 160. In a non-limiting embodiment, system 500 can communicatively connect platform server device(s) 102 with requestor device 104A, provider device 104B, courier device 104C, locker computing device(s) 106, and smart locker device(s) 108 via network 114.

Accordingly, provider device(s) 104B accesses platform server device(s) 102 to provision smart locker services for target requestors. Furthermore, provider device(s) 104B may initiate an onboarding of smart locker device 108 to platform server device(s) 102 via scanning device 108 serial number and identifying the smart locker type for onboarding. Smart locker device 108 can interface with platform server device(s) 102 via locker computing device(s) 106 and enable operability and functionality capabilities of platform server device 102 for access by smart locker device 108. In another aspect, provider device 104B can provision and receive commands, instructions, queries, and information via provider communication interface 520 employed by gateway and integration layer 158.

In an embodiment requestor device(s) 104A can provision and receive commands, instructions, queries, and information via requestor communication interface 510 employed by gateway and integration layer 158. As such, requestor device 104A can provision queries or initiate instructions to search for smart lockers via locations, proximity to a location, generate routes, generate maps of smart locker locations, identify requirements of smart lockers, smart locker functionality, provision ratings of smart locker usage, request usage of smart lockers, provision payments, and communicate with network stakeholders as well as provide a range of other tasks, operations, and functions.

In another embodiment, courier device(s) 104C can provision and receive commands, instructions, queries, and information via courier communication interface 530 employed by gateway and integration layer 158. In an aspect interface 510, 520, and 53o can enable and manage communication between devices 104A, 104B, 104C, 106, and 108 and request such devices respectively. In some examples, devices 104A, 104B, 104C, 106, and 108 can communicate with respective interfaces via applications executing on the devices.

In another aspect, system 500 can employ first communication module 170, provider communication interface 520, and requestor communication interface 510 to receive data from a range of requesting devices, provider devices, and smart locker devices 108. A variety of information can be provided such as device information, user profile information (e.g., email, identifiers, names, addresses, etc.), smart locker type (e.g., manufacturer, serial numbers, number of compartments, design configurations, etc.), location of smart lockers (e.g., GPS data), historical data (e.g., previous pickups, drop offs), previous requests for services, previous provisioning of services, smart locker failures, storage capacity of compartments, current inventory capacity, timings of pickups and drop offs and other such information.

In an aspect, interfaces 510, 520, and 530 can employ one or more application programming interface (API), such as an externally facing API, to communicate data with the interfaces of device(s) 104A, 104B, 104C, 106, or 108. As such, an externally facing API can communicate data with first communication module 170 and provide a secure access channel over network component 114 through any number of API mechanisms such as restful API's remote procedure call (RPC), Simple Object Access Protocol (SOAP), scripting access and other such access methods. As such, only authorized requestor devices 104A, provider devices 104B, authorized smart locker devices 108 and other such authorized parties can access platform server device(s) 102.

In an aspect, platform server device(s) 102 components and modules can combine to provision on-demand smart locker service availability and locations to service requestors. Platform server device(s) 102 allows service requestors to select a smart locker based on service requestor requirements. For instance, a service requestor may seek to identify smart lockers within a target geographic proximity, or along a particular route, offering services (e.g., storage of packages for pickup or delivery) within a price range, having respective operable functions (e.g., refrigerated compartments, sanitization features such as UV disinfection capabilities), easily accessible (e.g., smart locker positioned in a garage of a residential home), along a courier route (e.g., respective courier companies service such smart locker), and other such requirements.

In a non-limiting embodiment, platform server device(s) 102 also allows smart locker service providers to onboard smart lockers within a network of smart lockers such that the smart locker device(s) 108 can be identified as a service provider for service requestors. Furthermore, the smart locker device(s) 108 can be integrated with exchange location generation component 271 and platform server device(s) 102 smart locker operability, smart map generation, smart route generation and user device connectivity integrations. Accordingly, platform server device(s) 102 can be configured to operate in connection with one or more server device(s) communicatively coupled to requestor device 104A, provider device 104B, courier device 104C and/or smart locker device 108. In an aspect, requestor device 104A can be a mobile device (e.g., smart phone, tablet, etc.), desktop computer, or other such device executing an application that communicates with platform server device(s) 102 (e.g., server devices). Requestor device 104A can be operated by users seeking to identify, locate, and utilize smart locker services such as couriers or individual consumers needing to drop off or pickup parcels in smart lockers.

In another aspect, provider device 104B can be a mobile device (e.g., smart phone, tablet, etc.), desktop computer, or other such device executing an application that communicates with system 500 (e.g., server devices) via network 114. In a non-limiting instance, provider device 104B can be a smart phone executing an application that enables an service provider (e.g., owner of a smart locker) to onboard its smart locker to platform server device(s) 102, select requirements for use of the smart locker (e.g., time availability, type of users permitted to access the smart locker, price to use, permitted couriers, and contents permitted for storage, restrictions or allowances for parking, etc.), and enable the smart locker to be identified by service requestors.

In yet another aspect, platform server device(s) 102 can be configured to communicatively operate in connection with smart locker device 108 (e.g., via network 114). The smart locker device 108 can be any of a range of smart lockers including, but not limited to residential smart lockers (e.g., single family home use, residential locker installs, installations in garages), retail smart lockers (e.g., smart locker PoD's or locker banks installed at commercial settings), smart lockers 108 with customized features (e.g., refrigerated lockers, sanitization compartments, etc.), and other such smart lockers. Platform server device(s) 102 can integrate exchange location operations with other smart locker capabilities such as monitoring package delivery and pickup, transmitting notifications to service requestor device 104A and provider device 104B, single sign on capabilities, authentication capabilities, analytics capabilities, querying smart locker information, executing auditing tasks related to smart locker usage or management, and other such capabilities.

In another non-limiting embodiment, platform server device(s) 102 can be configured to communicate with courier device(s) 104C. Courier device(s) 104C can access exchange location generation component 271 to generate routes, and identify smart locker device(s) 108 locations to perform package pick-up and drop-off operations. Furthermore, courier device(s) 104C can represent an institutional courier such as a delivery service company device or an independent party device (e.g., user device) performing courier tasks on behalf of a requestor, company device or other entity. As such, gateway and integration layer 158 communicates with respective devices based on its authorized role. Furthermore, exchange location generation component 271 executes tasks and renders interfaces differently to different device roles accessing platform server device(s) 102. Furthermore, database(s) 160 may curate data and information at different sources, via different structures based on the type of external device interaction.

In other non-limiting embodiments, disclosed herein are systems, methods, and devices for allowing client devices 104 (e.g., provider devices, requestor devices, smart locker devices, courier requestor devices, etc.) to provision or query locations of smart lockers available and accessible to the user client devices 104. For instance, several client devices 104 can input information (e.g., via input module 192) related to the location of a smart locker (e.g., an address location, a GPS identifier, access credentials, instructions for use, restrictions on use, operability of the smart locker, hours of operation, etc.) and offer access to the smart locker (e.g., smart locker device(s) 108) for requestor device(s) 104A access, use, and operate (e.g., unlock locker door, store packages in smart locker compartment, pickup packages in compartment, permit courier to access compartment, etc.) at that physical location of the smart locker device 108.

As such, a provider device 104B may identify a smart locker device 108 controlled by the provider device 104B as available for access by requestor device(s) 104A. The smart locker device 108 may be located within a garage space of a residential home controlled by provider device 104B. As such, provider device 104B can offer via platform server device(s) 102 for other client device(s) 104 (e.g., courier device 104C, requestor device 104A) to access the garage located smart locker device(s) 108 as a destination hub for package delivery and package pickup operations. Furthermore, in the absence of a smart locker device, a provider device can offer the use of space (e.g., garage space) for installation of a hub or use as a mailroom by requestor device(s) 104A, courier device(s) 104C or other client device(s). Furthermore, a provider device(s) 104B can offer access to a multi-compartment locker bank device or several smart locker banks within the garage space in order to allow for a secure storage mechanisms for several user devices to access, utilize and operate smart locker devices and compartments.

In the case of a courier, a courier device 104C can securely and efficiently drop-off or pick-up several packages to such destination location (e.g., residential home with smart locker device installation). In an aspect, the platform server device(s) 102 employing exchange location generation component 271 can enable any provider device(s) 104B to offer access, usage and operable control of smart locker device(s) 108 and enable package storage and delivery transactions to take place at the location of the smart locker device(s) 108 or mailroom transactions at the designated real estate location. As such, in a non-limiting instance, a users' garage can be offered and utilized as a shared space facilitating an exchange of packages or other items in order to reduce the number of miles both couriers (e.g., who would otherwise visit multiple single-family homes) and customers (e.g., who would otherwise have to visit the post office) would have to travel to exchange (e.g., deliver, pick-up, drop-off) items (e.g., packages, goods, products, etc.). As such, a users' garage (e.g., with installed smart locker device(s) 108 in some instances) can serve as a last mile or last-yard hub for an exchange of items.

In another aspect, the systems, methods, and devices disclosed herein can facilitate courier device(s) 104C to select alternative drop off points for one or more packages that can fit efficiently within their delivery route and minimize cost pain points such as those posed by the last mile dilemma. In yet another aspect, requestor device(s) 104A corresponding to package owners can utilize the smart locker device(s) 108 for safe package storage until a pickup operation is conducted (e.g., via a courier device(s) 104C convenient to them (e.g., at smart locker device(s) 108 locations near the package owners residential or work address). Furthermore, platform server device(s) 102 can identity and track the chain of custody and chain of identity of a package as it travels through the transportation chain including through a smart locker device(s) 108.

In another non-limiting embodiment, an offered smart locker device(s) location for package storage can serve as a delivery site for a courier device 104C or a requestor device 104A, a pickup location for a courier device(s) 104C or requestor device 104B to receive an incoming parcel, and/or a drop-off location for a requestor device 104B to leave a package for courier device 104C to pick up (e.g., return or shipping a parcel with a pre-addressed label).

In an aspect, system 500 can comprise a memory that stores computer executable components; a processor that executes the computer executable components stored in the memory, wherein the computer executable components (e.g., exchange location generation component 271) can receive a set of location data representing available locations for storing packages and verify the set of location data has been selected for use in storing packages. In an aspect, system 500 can act as a platform that allows a provider device 104B that can represent an owner of real estate and smart locker device 108, a requestor device 104A that can represent a user needing to drop off or pick up a package, and a courier device 104C that can represent a package delivery organization that drops and picks up packages. In an aspect, provider device 104B can execute a client application that inputs information such as smart locker device 108 serial number, identification information, location of smart locker, and restrictions or requirements for smart locker use and operability. In another aspect, each device can comprise one or more processor to execute system components. Furthermore, each device can comprise one or more memory to store the executable components. Also, in an aspect, applications to access platform server device(s) 102 and platform modules can be executed and operated on any of device 104A, 104B, 104C, and locker computing device(s) 106. In another aspect, all such devices can communicate with network component 114 and other devices via network component 114.

In an aspect, system 500 allows any owner of real estate (e.g., via provider device 104B) to offer to utilize its room or open space for storing packages. As such, system 500 allows for the decentralization of storage warehouses and facilities by empowering every user device to allow its owner to use its space for storing packages. Furthermore, in an aspect, each owner can implement a smart locker device(s) 108 within the space to facilitate secure storage, delivery, and/or retrieval of items (e.g., packages, mail, articles, etc.). Accordingly, a homeowner can install a smart locker device(s) 108 (hardware and software) and a universal interface circuit at a location owned by the homeowner (e.g., garage) and provision several storage compartments for permitted access by delivery companies, third part individuals acting as couriers, individuals on their own behalf, to drop off and/or pickup several packages at the garage location and allowing several consumers to drop off and/or pickup packages at the garage location. Furthermore, a provider (e.g., via provider device 104B) can indicate a range of available timings for the smart locker device(s) 108 to be accessible and can indicate other preferences related to transactions (e.g., requirements on package sizes, requirements on delivery/pickup times, blackout dates, etc.)

Also, in an aspect, the delivery organization can configure (e.g., via courier device 104C) delivery logistics (e.g., routes, multiple package deliveries, etc.) in accordance with the new warehousing and storage options for package drop-off and pickup. Furthermore, the delivery organization can consolidate costs by reducing the last mile issue. In another aspect, the delivery organization can negotiate costs and other terms with the owner of the storage facility. Accordingly, system 500 can represent a platform that brings numerous user devices representing different parties together to facilitate package storage, delivery, and pickup tasks.

In another aspect, platform server device(s) 102 can receive a set of location data representing available locations for storing packages. As such, a provider device 104B can access platform server device(s) 102 and offer to provide its space (e.g., location and identified smart locker device) as a drop off and/or pickup location of packages. A courier device 104C or requestor device 104A choosing to drop off or pick-up a package can view the smart locker device location and select whether or not to the location of the smart locker device is a desirable drop off and pickup location. Furthermore, the requestor device 104A or courier device 104C can also indicate whether the provider device 104B location is acceptable as a storage location for its packages. If any combination of, individually or together, a courier device 104C and a requestor device 104B agree with provider device 104A to select the smart locker device(s) 108 as an acceptable drop off and pickup location then the transaction can be verified (e.g., by platform server device(s) 102) as the selected location for storage of packages. In other non-limiting embodiments, the requestor device 104A and courier device 104C can indicate a preferred smart locker device 108 from a list of smart locker devices and corresponding locker locations. In other embodiments, requestor device 104A can also select a courier device 104C whom pre-approves or accepts the selected smart locker device location for pickup and/or drop-off of packages.

As a non-limiting example, residents and/or businesses (represented by provider device 104B) can utilize a garage or home as a hub for receiving, dropping off, or picking up deliveries of packages. As such, provider device 104B can access platform server device(s) 102 and generate a user profile to associate with smart locker device(s) and offers to access, control and use such smart locker devices at various locations. In another non-limiting example, system 500 can be used by couriers (represented by courier devices 104C) who are interested in consolidating deliveries and can utilize locations associated with provider devices 104B (owners offering their owned space as storage facilities) as pickup and/or drop-off points. As such, courier device(s) 104C can access platform server device(s) 102 and select pickup and/or drop-off points for packages. In another non-limiting example, residents or consumers or senders of packages (represented by second user devices) can utilize system 500 (e.g., via requestor device 104A to send or receive packages at selected locations.

As an example, a provider device 104B can indicate its location for drop off or pickup of packages via a smart locker device installed in a garage. As such, provider device 104B accesses system 500 to indicate that its garage is populated with smart locker devices comprising various technical capabilities (e.g., smart shelf, vision technology) to facilitate recordation of a proper chain of custody transaction between users of the storage lockers (e.g., identify all user devices and corresponding user profiles whom access the storage locker for drop off and/or delivery). Furthermore, the provider device 104B can indicate that the smart locker devices are available during permitted hours of operation (e.g., in the garage location 24 hours a day and seven days a week) via a stated access mechanism (e.g., through the opening of the garage door or by equipping the garage door with an application technology, electronic keypad or other means to open the garage door and access the smart lockers). Also, in a non-limiting instance, the provider device 104B can open the garage door on-demand after authenticating the parties for exchange transactions. Accordingly, system 500 can be utilized in diverse scenarios to connect various user devices and facilitate drop off and delivery transactions in a meaningful, cost-effective, and efficient manner.

In an aspect, the systems disclosed herein can recite cloud computing implementations, however, the subject disclosure is not limited to utilizing a cloud computing environment. In an aspect, cloud computing can refer to a service model for providing or enabling a convenient, on-demand access to a network that can include a shared pool of computing resources (e.g., networks, network bandwidth, servers, processing, memory, storage, applications, virtual machines, and services) capable of configuration and able to be rapidly deployed for use with other devices and requires limited management. This cloud model may include characteristics such as on-demand self-service, measured service, rapid elasticity, broad network access, and/or resource pooling.

Furthermore, cloud computing can be deployed using any of several service models such as the software as a service model, the infrastructure as a service model and/or the platform as a service model. In another aspect, the cloud computing model can be deployed using any of numerous deployment models such as a hybrid cloud model, a public cloud model, a private cloud model and/or a community cloud model. A notable feature of a cloud computing model is the relationship of numerous connected nodes that form a network. These networks allow for the interoperability of several devices. For instance, in an aspect, a local computing device can communicate with consumer devices (e.g., smart phones) using a cloud computing network of nodes. The cloud environment allows for personal devices to not require the maintenance of resources on a local device and instead utilize the cloud as an infrastructure or extension of the personal device. In an aspect, the cloud can include several layers such as a hardware layer, a software layer, a virtualization layer, a management layer, workload layer, an analytics processing layer, a software development layer and a command layer in our subject disclosure that allows for the communication with a locker device from a personal user device by utilizing a cloud infrastructure.

It is to be appreciated that the examples described here are for illustrative purposes, and other types of machine-learning algorithms and/or distribution methods can be utilized without departing from the scope of the claimed subject matter, such as preference elicitation models, multiple-criteria decision analysis models, statistic-based predictive models, and so forth.

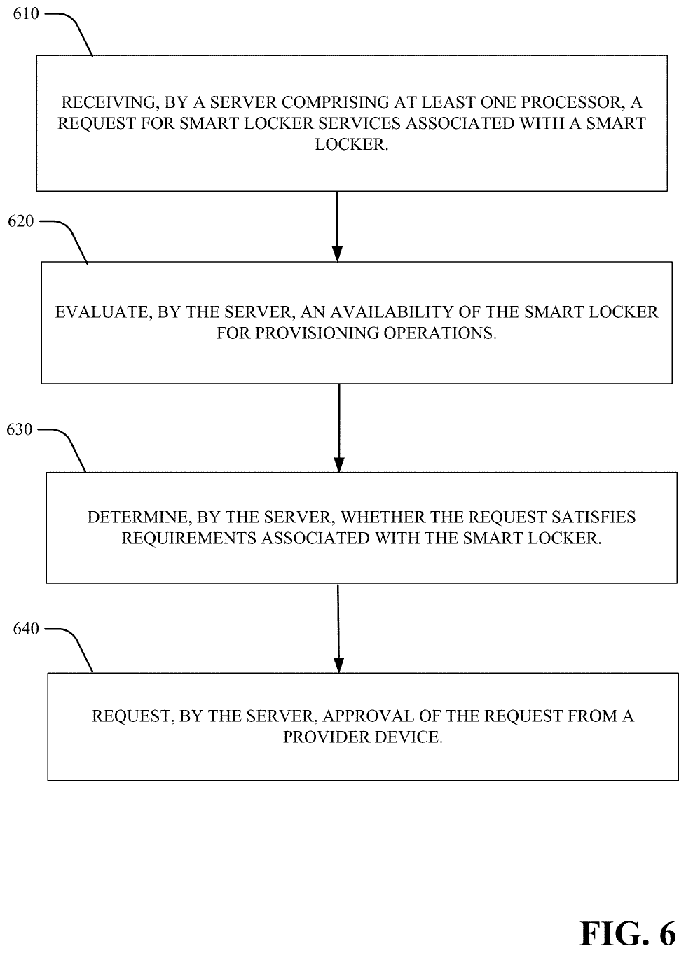

Now consider FIG. 6 that illustrates an example method 600 that can be utilized to generate a smart locker exchange location network in accordance with one or more implementations. Repetitive description of like elements employed in other embodiments described herein is omitted for sake of brevity.

The method can be performed by any suitable combination of hardware, software, and/or firmware. In at least some embodiments, aspects of the method can be implemented by one or more suitably configured hardware components and/or software modules, such as various hardware and/or software modules associated with server device(s) 102, application device(s) 103, client device(s) 104, and/or locker computing device(s) 106 of FIG. 1, such as various modules included in smart locker platform module 106, LDOS module 180, Client smart locker module 181, mailroom application 171, service application 172, package room application 174, inventory application 173, presentation layer 185, and/or core application layer 183. While the method described in FIG. 6 illustrates these steps in a particular order, it is to be appreciated that any specific order or hierarchy of the steps described here is used to illustrate an example of a sample approach. Other approaches may be used that rearrange the ordering of these steps. Thus, the order of the steps described herein may be rearranged, and the illustrated ordering of these steps is not intended to be limiting.

At 610, various implementations access a smart locker platform module 106 executing on a server device 102. For example, a client device 104 can include a client application (e.g., client services module 110) configured to access smart locker platform module 106 and/or a browser that can access an application (e.g., exchange location generation module 271) of the server device. Furthermore, smart locker platform module 106 can receive a request from a client application for smart locker services associated with a smart locker device 108. At 620, the smart locker platform module 106 executing on server device 102 can evaluate, by the server, an availability of the smart locker for provisioning operations. At 630, the smart locker platform module 106 executing on server device 102 can determine whether the request satisfies requirements associated with the smart locker. At 640, the smart locker platform module 106 executing on server device 102 can request approval of the request from a provider device (e.g., client device 104).

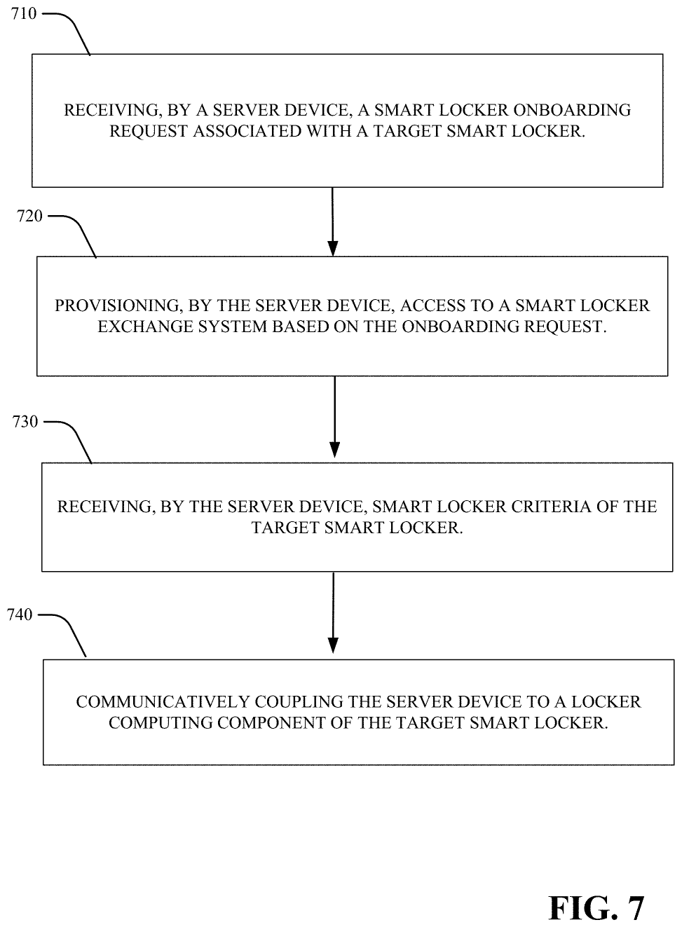

Now consider FIG. 7 that illustrates an example method 700 that can be utilized to generate a smart locker exchange location network in accordance with one or more implementations. Repetitive description of like elements employed in other embodiments described herein is omitted for sake of brevity.

At 710, a server device (e.g., server device(s) 102) receives a smart locker onboarding request (e.g., from client device(s) 104) associated with a target smart locker (e.g., smart locker device(s) 108). At 720, the server device provisions access to a smart locker exchange system based on the onboarding request. At 730, the server device receives smart locker criteria of the target smart locker. At 740m the server device communicatively couples to a locker computing component (e.g., locker computing device(s) 106 of the target smart locker (e.g., smart locker device(s) 108).

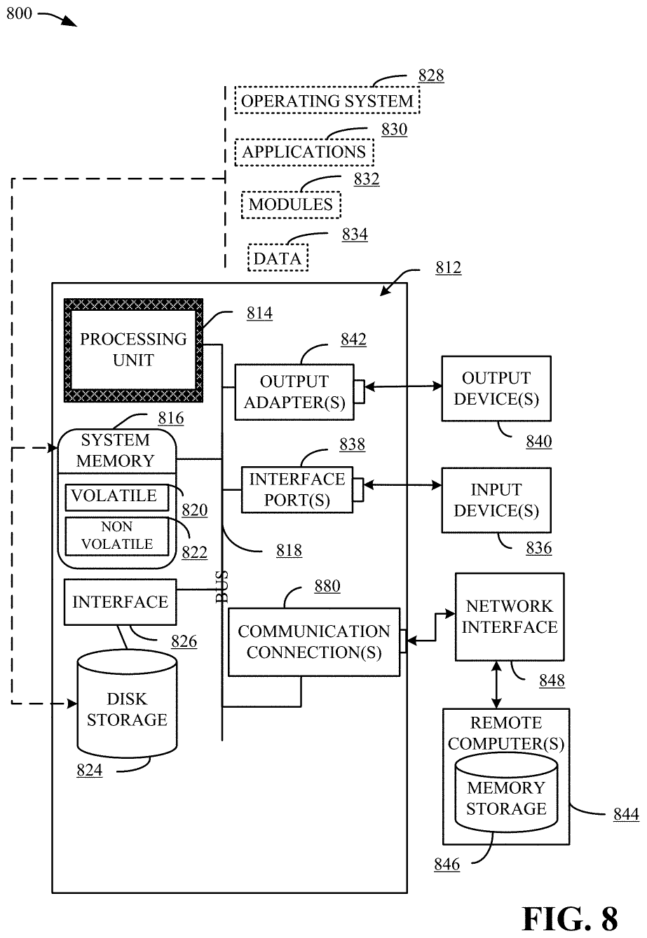

In order to provide a context for the various aspects of the disclosed subject matter, FIG. 8 as well as the following discussion is intended to provide a general description of a suitable environment in which the various aspects of the disclosed subject matter can be implemented. FIG. 8 illustrates a block diagram of an example, non-limiting operating environment in which one or more embodiments described herein can be facilitated. With reference to FIG. 8, a suitable operating environment 800 for implementing various aspects of this disclosure can also include a computer 812. The computer 812 can also include a processing unit 814, a system memory 816, and a system bus 818. The system bus 818 couples system components including, but not limited to, the system memory 816 to the processing unit 814. The processing unit 814 can be any of various available processors. Dual microprocessors and other multiprocessor architectures also can be employed as the processing unit 814. The system bus 818 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 816 can also include volatile memory 420 and nonvolatile memory 822. The basic input/output system (BIOS), containing the basic routines to transfer information between elements within the computer 812, such as during start-up, is stored in nonvolatile memory 822. By way of illustration, and not limitation, nonvolatile memory 822 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 820 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 812 can also include removable/non-removable, volatile/non-volatile computer storage media. FIG. 8 illustrates, for example, a disk storage 824. Disk storage 824 can also include, but is not limited to, devices like a magnetic disk drive, floppy disk drive, tape drive, Jaz drive, Zip drive, LS-100 drive, flash memory card, or memory stick. The disk storage 824 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 824 to the system bus 818, a removable or non-removable interface is typically used, such as interface 826. FIG. 8 also depicts software that acts as an intermediary between users and the basic computer resources described in the suitable operating environment 800. Such software can also include, for example, an operating system 828. Operating system 828, which can be stored on disk storage 824, acts to control and allocate resources of the computer 812.

System applications 830 take advantage of the management of resources by operating system 828 through program modules 832 and program data 834, e.g., stored either in system memory 816 or on disk storage 824. It is to be appreciated that this disclosure can be implemented with various operating systems or combinations of operating systems. A user enters commands or information into the computer 812 through input device(s) 836. Input devices 836 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 814 through the system bus 818 via interface port(s) 838. Interface port(s) 838 include, for example, a serial port, a parallel port, a game port, and a universal serial bus (USB). Output device(s) 840 use some of the same type of ports as input device(s) 836. Thus, for example, a USB port can be used to provide input to computer 812, and to output information from computer 812 to an output device 840. Output adapter 1242 is provided to illustrate that there are some output device 840 like monitors, speakers, and printers, among other such output device 840, which require special adapters. The output adapters 842 include, by way of illustration and not limitation, video and sound cards that provide a means of connection between the output device 840 and the system bus 818. It should be noted that other devices and/or systems of devices provide both input and output capabilities such as remote computer(s) 844.

Computer 812 can operate in a networked environment using logical connections to one or more remote computers, such as remote computer(s) 844. The remote computer(s) 844 can be a computer, a server, a router, a network PC, a workstation, a microprocessor based appliance, a peer device or other common network node and the like, and typically can also include many or all of the elements described relative to computer 812. For purposes of brevity, only a memory storage device 846 is illustrated with remote computer(s) 844. Remote computer(s) 844 is logically connected to computer 812 through a network interface 848 and then physically connected via communication connection 850. Network interface 848 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 850 refers to the hardware/software employed to connect the network interface 848 to the system bus 818. While communication connection 850 is shown for illustrative clarity inside computer 812, it can also be external to computer 812. The hardware/software for connection to the network interface 848 can also include, for exemplary purposes only, internal and external technologies such as, modems including regular telephone grade modems, cable modems and DSL modems, ISDN adapters, and Ethernet cards.

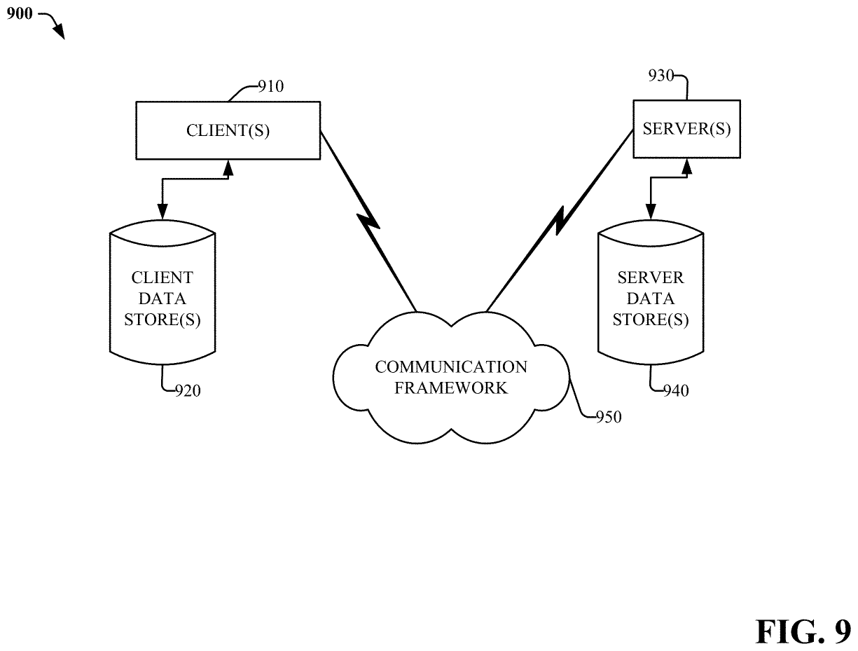

Referring now to FIG. 9, there is illustrated a schematic block diagram of a computing environment 900 in accordance with this disclosure. The system 900 includes one or more client(s) 902 (e.g., laptops, smart phones, PDAs, media players, computers, portable electronic devices, tablets, and the like). The client(s) 902 can be hardware and/or software (e.g., threads, processes, computing devices). The system 900 also includes one or more server(s) 904. The server(s) 904 can also be hardware or hardware in combination with software (e.g., threads, processes, computing devices). The servers 904 can house threads to perform transformations by employing aspects of this disclosure, for example. One possible communication between a client 902 and a server 904 can be in the form of a data packet transmitted between two or more computer processes wherein the data packet may include video data. The data packet can include a metadata, e.g., associated contextual information, for example. The system 900 includes a communication framework 906 (e.g., a global communication network such as the Internet, or mobile network(s)) that can be employed to facilitate communications between the client(s) 902 and the server(s) 904.

Communications can be facilitated via a wired (including optical fiber) and/or wireless technology. The client(s) 902 include or are operatively connected to one or more client data store(s) 908 that can be employed to store information local to the client(s) 902 (e.g., associated contextual information). Similarly, the server(s) 904 are operatively include or are operatively connected to one or more server data store(s) 910 that can be employed to store information local to the servers 904. In one embodiment, a client 902 can transfer an encoded file, in accordance with the disclosed subject matter, to server 904. Server 904 can store the file, decode the file, or transmit the file to another client 902. It is to be appreciated, that a client 902 can also transfer uncompressed file to a server 904 and server 904 can compress the file in accordance with the disclosed subject matter. Likewise, server 904 can encode video information and transmit the information via communication framework 906 to one or more clients 902.

The present disclosure may be a system, a method, an apparatus and/or a computer program product at any possible technical detail level of integration. The computer program product can include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
one or more processors; and
one or more storage devices comprising processor executable instructions that, responsive to execution by the one or more processors, cause the system to perform operations comprising:
receiving a set of identity information of smart lockers from provider devices;
permitting the smart lockers, the provider devices and requestor devices to access a server;
generating, based on smart locker access requests and smart locker offers by requestor devices and provider devices respectively, a smart locker exchange network comprising the smart lockers, the server device, the provider devices, and the requestor devices.

2. The system of claim 1, further comprising:
accessing, by a hardware abstraction layer communicatively coupled to a first smart locker and a second smart locker of the smart lockers, the server device, wherein the first smart locker and the second smart locker comprise different hardware components.

3. The system of claim 1, further comprising:
operatively controlling, by the server device, the smart lockers based on executable tasks initiated by the provider devices or the requestor devices.

4. The system of claim 1, further comprising:
determining, by the server device, locations of at least some of the smart lockers based on requested smart locker criteria.

5. The system of claim 4, further comprising:
Generating, by the server device, a location map of the at least some of the smart lockers based on identifying locations.

6. The system of claim 1, further comprising:
receiving, by the server device, a query to determine at least some of the smart lockers satisfying request criteria.

7. The system of claim 1, further comprising:
an extraction module configured to extract insights from curated smart locker data based, at least in part, on a query analysis.

8. The system of claim 6, further comprising:
generating a location map identifying locations of target smart lockers of the smart lockers based on the query; and
provisioning the location map to a requestor device.

9. The system of claim 6, further comprising:
selecting at least two of the smart lockers based on the query; and
generating a route between the at least two of the smart lockers.

10. The system of claim 1, further comprising:
receiving a serial number of the smart lockers, wherein the serial number represents at least one of a make, a type, and a manufacturer of a smart locker of the smart lockers;
identifying a universal interface circuit integrated within the smart locker; and
communicatively coupling the smart locker to the server device.

11. The system of claim 1, further comprising:
provisioning operable commands to the smart lockers based on instructions from an authorized requestor device.

12. The system of claim 1, further comprising:
implementing operability requirements of the smart lockers;
identifying a satisfaction of the operability requirements of the smart lockers; and
triggering operational events of the smart lockers based on the satisfaction of the operability requirements.

13. The system of claim 1, further comprising:
generating a user profile rating corresponding to a provider device, a smart locker of the smart lockers, or a requestor device.

14. The system of claim 1, further comprising:
determining a state of the smart lockers, wherein a state can comprise at least one of a power on state, inactivated state, idle state, awake state, manual input state, emergency/notification state, and/or application interaction state.

15. A computer-implemented method comprising:
receiving, by a server device, a smart locker onboarding request associated with a target smart locker;
provisioning, by the server device, access to a smart locker exchange system based on the onboarding request;
receiving, by the server device, smart locker criteria of the target smart locker; and
communicatively coupling the server device to a locker computing component of the target smart locker.

16. A computer-implemented method comprising:
receiving, a server comprising at least one processor, a request for smart locker services associated with a smart locker;
evaluate, by the server, an availability of the smart locker for provisioning operations;
determine, by the server, whether the request satisfies requirements associated with the smart locker; and
request, by the server, approval of the request from a provider device.

17. The computer-implemented method of claim 16, further comprising:
generate, by the server, route information from a start location to a smart locker location based on an approval; and
provision, by the server, the route information to a requestor device and a scheduled locker reservation to a locker computing device.

18. The computer-implemented method of claim 17, further comprising:
trigger, by the server, a first notification to the provider device of a proximity of the requestor device to the smart locker or arrival of the requestor device at the smart locker location; and
trigger, by the server, a second notification based on an operational event of the smart locker.
